(19) United States
(12) Patent Application Publication
(10) Pub. No.: US 2006/0113071 A1
(43) Pub. Date: Jun. 1, 2006

(54) Heating or air-conditioning system for a motor vehicle

(76) Inventor: Reinhold Weible, Stuttgart (DE)

Correspondence Address: KENYON & KENYON LLP, ONE BROADWAY, NEW YORK, NY, 10004, US

(21) Appl. No.: 11/158,451

(22) Filed: Jun. 21, 2005

(30) Foreign Application Priority Data
Jun. 26, 2004 (DE) 10 2004 030 993.0

(51) Int. Cl. B60H 3/00; B60H 1/00; B61D 27/00

(52) U.S. Cl. 165/202; 165/42

(57) ABSTRACT

A heating and/or air-conditioning system for a motor vehicle includes a heater circuit having a heat exchanger that has heating water flowing through it for bringing climate control air to be supplied to a vehicle interior to the right temperature, a supply line for supplying hot heating water to the heat exchanger, a return line for removing cooled heating water from the heat exchanger and a control valve for regulating the flow quantity of the heating water flowing through the heat exchanger. The supply line and the return line are provided to be thermally coupled at least along a part of their length outside of the heat exchanger.

### FIELD OF THE INVENTION

The present invention relates to a heating and/or air-conditioning system for a motor vehicle, including a heater circuit having a heat exchanger that has heating water flowing through it for bringing climate control air to be supplied to a vehicle interior to the right temperature, a supply line for supplying hot heating water to the heat exchanger, a return line for removing cooled heating water from the heat exchanger and a control valve for regulating the flow quantity of the heating water flowing through the heat exchanger.

### BACKGROUND INFORMATION

At low to medium heater outputs, heating or air-conditioning systems for motor vehicles that are water-controlled by a throttle valve have the disadvantage of an uneven temperature distribution across the air-flow-exposed surface of the heat exchanger, which is also referred to as the radiator. Depending on whether the design of the heat exchanger has horizontal or vertical heat exchanger pipes, this will result in horizontal or vertical temperature gradients, which are greatest if the heat exchanger is operated at a low heater output and in this instance has low quantities of heating water flowing through it. In addition, the flow through the parallelly connected heat exchanger pipes is not reproducible at low flow quantities since the flow of the heating water in the heat exchanger is influenced by the different densities of the hot and the cooled heating water, by forces of lag and acceleration as a result of the specific driving states of the motor vehicle as well as by thermosiphon forces.

An uneven temperature distribution across the heat exchanging surface of the heat exchanger, however, has the result that the climate control air flowing through the heat exchanger to different air outlet nozzles in the motor vehicle can also have different temperatures from one air outlet nozzle to another and/or across the outlet cross section of a single air outlet nozzle.

Since the heater output in conventional motor vehicle heating and/or air-conditioning systems that are water-controlled by a throttle valve depends mainly on the heating water flow rate, which in turn depends on the current rotational speed of a main water pump driven by the driving engine of the motor vehicle and thus on the rotational speed of the driving engine, such heating or air-conditioning systems usually have an electronic temperature control, which is generally based on the measured climate control air temperature behind the heat exchanger. If at low heater outputs, however, an uneven and non-reproducible temperature distribution across the heat exchanger and thus also at the previously defined measuring points occurs, satisfactory control results can only be obtained using such a control system only if additional measures are taken for reducing or avoiding temperature differences, as for example a complex flow in the heat exchanger, an additional circulating pump connected in parallel to the heat exchanger, a hydraulic bridge having an auxiliary water pump and a return intermixing valve, a four-way mixing valve having an auxiliary water pump in the heater circuit, or a plurality of temperature sensors having a fixed or output-dependent weighting or of temperature sensors behind the heat exchanger that operate in a spatially integral manner.

Frequently, however, an air-based temperature control is preferred, in which the temperature of the air supplied to the vehicle interior is changed with the aid of blending flap, which in heating operation directs a smaller or greater portion of the air past the heat exchanger depending on the desired heater output. For cooling operation, a shutoff valve is provided there in the heater circuit. Air-controlled motor vehicle heating or air-conditioning systems, however, also have a series of disadvantages, for example a substantial additional requirement of space for the installation of the blending flap and for an air-blending chamber as well as the production of stronger turbulences, which are required for the complete mixing of the cold air flow, but which result in louder flow noises that are reflected into the vehicle's interior.

### SUMMARY OF THE INVENTION

The heating and/or air-conditioning system according to the present invention has the advantage that the disadvantages of water-controlled motor vehicle heating or air-conditioning systems mentioned at the beginning can be avoided using the simplest of means.

The present invention is based on the idea of using a thermal coupling of the supply line and of the return line to lower the supply temperature of the heating water, i.e. the temperature of the heating water as it enters the heat exchanger, where the extent to which the temperature is lowered increases with an increase of the time in which the heating water resides in the thermally coupled region and is thus all the greater, the smaller is the flow rate or the volume flow of the heating water. A lowering of the supply temperature has the immediate consequence that the climate control air supplied to the heat exchanger is heated to a lesser degree at the heat exchanging surfaces of the heat exchanger. In an electronic temperature control as a function of the measured air temperature behind the heat exchanger, this has the consequence that the control or throttle valve in the heater circuit is opened more frequently or further and that thus the flow quantity of the heating water through the heat exchanger is increased. The greater flow quantity of the heating water again results in a certain rise of the supply temperature, an equilibrium setting in at static conditions, at which, in comparison to a conventional heating or air-conditioning system without thermal coupling between the supply line and the return line, the flow of water through the heat exchanger is many times higher at low heater outputs and clearly higher at medium heater outputs. The stronger flow through the heat exchanger at small or medium heater outputs in turn has the consequence of preventing an occurrence of vertical or horizontal temperature gradients across the heat exchanger and of reducing the influence of lag, acceleration and thermosiphon forces on the temperature distribution of the heating water in the heat exchanger. The air is thereby uniformly heated in the heat exchanger such that when emerging from the air outlet nozzles it has a homogeneous temperature distribution and in a satisfactory manner ensures the comfort in the heated or air-conditioned interior.

In order to ensure the best possible thermal coupling without additional components and without significant additional costs, a preferred refinement of the present invention provides for the supply line and the return line to be made of metal at least over a part of their length outside of the heat exchanger and to be in direct heat contact so as to ensure a good heat transfer from the hotter supply water to the cooler return water.

A particularly good heat transfer using the simplest of means is achieved if the supply line and the return line at least in the region of the thermal coupling take the form of flat pipes, the surfaces of their broadsides abutting against each other, and for improving their cohesion and the transfer of heat they can be additionally soldered together or be fixed adjacent to each other under pressure by a clamping connection.

In the case of a clamping connection, additionally a metallic heat transfer element in the form of a foil or a body having a cross-sectional form adapted to the cross-sectional form of the lines can be clamped in between the supply line and the return line so as in the latter case to increase the heat transfer cross section between the lines. Further, metallic connecting elements are suitably used for the clamping connection such as screws, rivets or springs, which likewise contribute toward improving the heat transfer between the supply line and the return line.

An improvement of the thermal coupling between the supply line and the return line may also, alternatively or additionally, be achieved by enclosing the two lines at least over a part of their length by an insulating shell, which is filled with a solid or liquid heat-conducting medium such as metal powder, grease, gel or oil.

Two other alternatives for improving thermal coupling provide for heat-conducting ribs to be attached at least in the region of the coupling in the interior of the lines, which conduct heat from the flow region of the heating water into the region of the contact surfaces between the lines and/or for interference elements to be installed which result in turbulences or swirls and thus improve the internal heat transfer from the water flow into the wall of the line.

According to another advantageous refinement of the present invention, the supply line and the return line run parallel with respect to each other in the region of the thermal coupling and there are preferably straight, which allows for a further reduction of the expenditure for the thermal coupling of the two lines.

Particularly in areas where the available space does not allow for a thermal coupling of the two lines over a sufficient length of at least 0.3 m and preferably of approximately 0.5 to 1.0 m, it is also possible to configure a coupling heat exchanger between the supply line and the return line, with the aid of which a portion of the heat of the hot cooling water from the supply line is transferred into the cooled cooling water in the return line.

As an alternative to a thermal coupling of the supply line and the return line outside of the heat exchanger, such a thermal coupling could in general also occur inside the heat exchanger, for example in that in a water compartment of the heat exchanger a coupling heat exchanger is situated, which ensures a thermal coupling between the supply water and the return water.

### BRIEF DESCRIPTION OF THE DRAWINGS

FIG. 1 shows a schematic representation of a cooling water and refrigerant circuit of a water-controlled heating and air-conditioning system of a motor vehicle having a heat exchanger for heating climate control air for a vehicle interior.

FIG. 2 shows a schematic sectional view through an instrument panel of the motor vehicle including the heat exchanger and a portion of its supply line and return line.

FIG. 3 shows a cut perspective view of a first variant of a thermal coupling between the supply line and the return line of the heat exchanger.

FIG. 4 shows a cross-sectional view of a second variant of a thermal coupling between the supply line and the return line of the heat exchanger.

FIG. 5 shows a cross-sectional view of a third variant of a thermal coupling between the supply line and the return line of the heat exchanger.

FIG. 6 shows a cross-sectional view of a fourth variant of a thermal coupling between the supply line and the return line of the heat exchanger.

### DETAILED DESCRIPTION

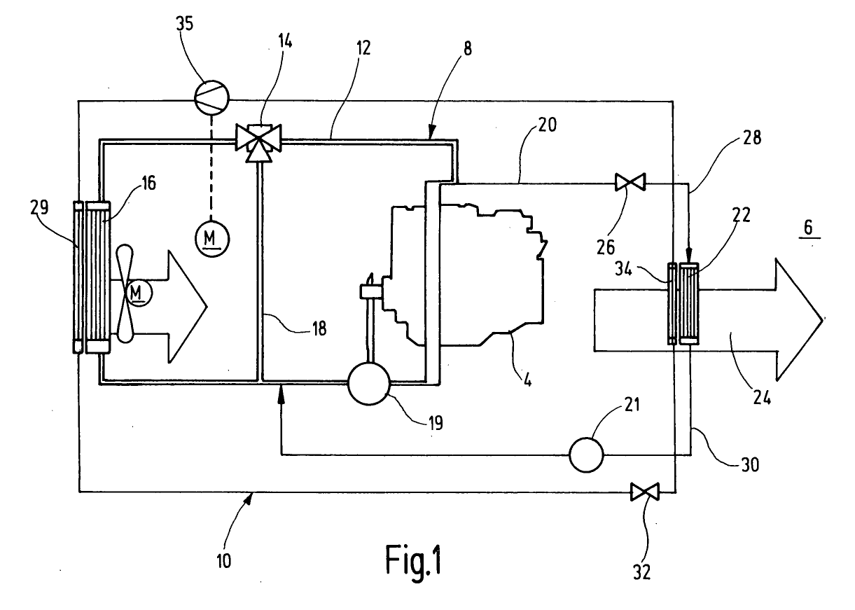

The thermo-system of a motor vehicle shown in a schematic and simplified manner in FIG. 1 includes cooling water circuit 8 used to control the operating temperature of a driving engine and for heating an interior 6 of the motor vehicle and a refrigerant circuit 10 used for cooling the interior 6.

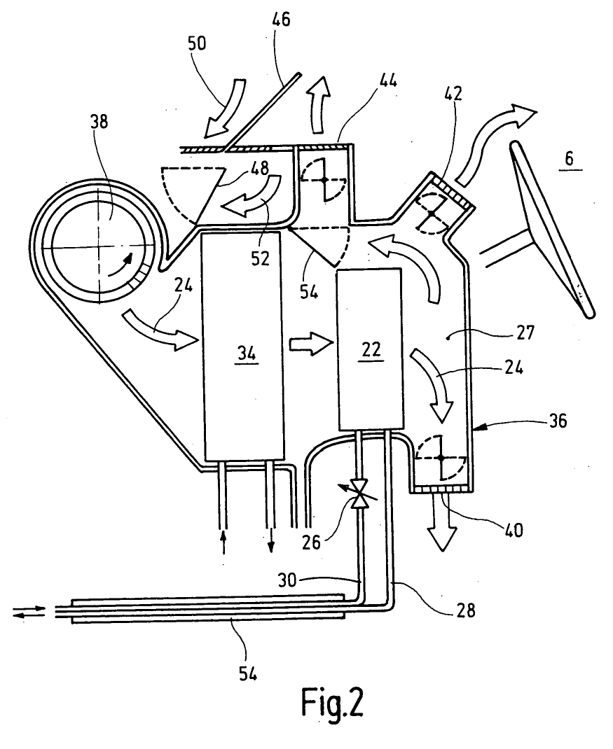

Cooling water circuit 8 includes a radiator circuit 12 for cooling driving engine 4, which runs from driving engine 4 via a three-way valve 14 to a radiator 16 or to a radiator bypass line 18 and from there via a mechanical main water pump 19 driven by driving engine 4 back to driving engine 4. Cooling water circuit 8 further includes a heating circuit 20 for heating interior 6, which in addition to an electrical supplemental water pump 21 has a heat exchanger 22 or radiator having a heat exchanging surface exposed to the flow of interior climate control air 24 as well as a control valve 26. Control valve 26 may be a throttle valve, the opening cross section of which is changed as a function of the air temperature in the climate control air flow 24 behind heat exchanger 22 measured by a temperature sensor 27 (FIG. 2), or a pulse-width modulated pulse valve, the opening and closing time of which is modulated by a PMW signal such that the flow quantity of the engine cooling water used as heating water may be throttled as required so as to provide climate control air 24 in heat exchanger 22 with the desired temperature. In the heating circuit 20 shown in FIG. 1, control valve 26 is situated in a supply line 28 running from driving engine 4 to heat exchanger 22, while supplemental water pump 21 is situated in a return line 30 running from heat exchanger 22 to driving engine 4, although a reverse arrangement is possible as well.

In a known manner, refrigerant circuit 10 includes a condenser 29 situated in front of radiator 16, an expansion valve 32, an evaporator 34 as well as a motor-driven air-conditioning compressor 35.

As shown best in FIG. 2, heat exchanger 22 together with evaporator 34 situated in climate control air flow 24 in front of heat exchanger 22 is accommodated in the region of an instrument panel 36 in such a way that the outer heat exchanging surfaces of evaporator 34 and of heat exchanger 22 are exposed to the flow of climate control air 24 conveyed by a fan 38 before the latter is discharged through air outlet nozzles 40, 42, 44 in the foot well, on instrument panel 36 and underneath a windshield 46 into interior 8. Via a controllable flap 48, alternatively fresh air 50 from outside of the motor vehicle or recirculating air 52 from interior 8 may be supplied to fan 38. Another controllable flap 54 allows for air 24 in cooling operation to be channeled past heat exchanger 22.

In order to prevent heat exchanger 22 at low or medium heater outputs from having an uneven temperature distribution on its heat exchanging surfaces exposed to the flow of air 24 as a result of a relatively low flow of hot heating water through it, supply line 28 and return line 30 have a thermally coupled region 54 along a part 54 of their length outside of heat exchanger 22. Due to such a thermal coupling of the two lines 28, 30, a part of the heat of the hot heating water is transferred to the cooled return water prior to its entry into heat exchanger 22, and the supply temperature of the heating water when entering heat exchanger 22 is thereby lowered. This has the result that climate control air 24 is heated to a lesser degree at the heat exchanging surfaces of heat exchanger 22, which in turn has the result that temperature sensor 27 measures an air temperature lying below the desired temperature and consequently opens control valve 26 further in the case of a throttle valve or sets longer opening times in the case of a pulse valve.

In comparison to a conventional heating circuit without thermal coupling of supply line 28 and return line 30, more heating water flows through heat exchanger 22 as a result. At very low heater outputs below 1 kW, this increases the flow quantity by multiples, while at medium heater outputs below 5 kW, the flow quantity is increased to a lesser degree but still markedly in that the heating water flow rate is typically doubled.

Due to the increased flow quantity, the heating water flows through heat exchanger 22 in a more uniform and more reproducible manner since it is then less influenced by lag, acceleration or thermosiphon forces. This in turn result in very small temperature gradients across the air-flow-exposed heat exchanging surface of heat exchanger 22 even at low heater outputs, and therefore to a more even temperature distribution in the air flowing through air outlet nozzles 40, 42, 44 into interior 8.

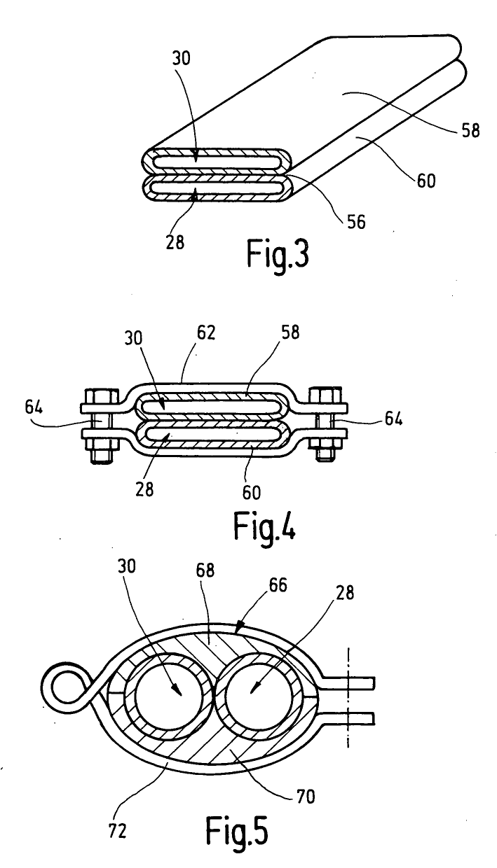

In order to ensure a sufficient thermal coupling of supply line 28 and return line 30 using the simplest and most cost-effective means, these can be configured, as shown in FIG. 3, in region 54 of the thermal coupling as metallic flat pipes 58, 60 running in parallel, whose adjacent broad faces at 56 are soldered to in a plane in order to ensure a good heat transfer between lines 28, 30.

Alternatively, the adjacent broad faces of lines 28, 30 configured as metallic flat pipes 58, 60 can also be pressed together using screw clamps 62, as shown in FIG. 4, metallic clamping screws 64 being suitably used so as to achieve a heat transfer not only via the broad faces but also via clamping screws 64.

Another improvement of the heat transfer using a clamping connection of the two lines 28, 30 is achieved if these are surrounded along a part of their length by a two-part heat transfer element 66 preferably made of metal, as shown in FIG. 5. The two parts 68, 70 of element 66 bound two recesses corresponding to the cross-sectional form of lines 28, 30 and are likewise pressed together by clamping collars 72 or alternatively by bolting such that they abut tightly against lines 28, 30 and preferably surround these completely.

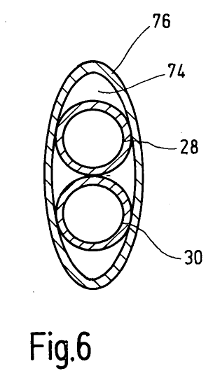

FIG. 6 shows another alternative, in which the two lines 28, 30, as in FIG. 5 for example, are configured as round pipes made from metal, but instead of being surrounded by a solid heat transfer element 68 are surrounded by a heat-conducting medium 74, which is enclosed in an outer shell 76 and which surrounds the two lines 28, 30 without gaps.

In places where the two lines 28, 30 for constructional reasons cannot be run parallel with respect to each other or can be run parallel to each other only over a length of less than 1.2 m, instead of the previously described thermal coupling of lines 28, 30, it is also possible to provide a coupling heat exchanger, which is connected to lines 28, 30 and which preferably has hot and cooled heating water flowing through it in a counter flow. Within the coupling heat exchanger, the two heating water flows are suitably run through a plurality of parallel thin channels such that supply channels and return channels are alternating.

To save space, it is also possible to integrate such a coupling heat exchanger into heat exchanger 22 or to accommodate it within the latter, for example in the water compartment.

What is claimed is:

1. A system for at least one of heating and air-conditioning of a motor vehicle, comprising:
a heater circuit having a heat exchanger that has heating water flowing through it for bringing climate control air to be supplied to a vehicle interior to a preselected temperature;
a supply line for supplying hot heating water to the heat exchanger;
a return line for removing cooled heating water from the heat exchanger; and
a control valve for regulating a flow quantity of the heating water flowing through the heat exchanger,
wherein the supply line and the return line are thermally coupled at least along a part of their length outside of the heat exchanger.

2. The system according to claim 1, wherein the supply line and the return line in a region of the thermal coupling are made of metal and are in direct heat contact.

3. The system according to claim 1, wherein the supply line and the return line in a region of the thermal coupling are configured as flat pipes and with their adjacent broad faces abut against each other in a plane.

4. The system according to claim 1, wherein the supply line and the return line in a region of the thermal coupling are soldered to each other.

5. The system according to claim 1, wherein the supply line and the return line in a region of the thermal coupling are connected to each other by a clamping connection.

6. The system according to claim 1, further comprising at least one metallic heat transfer element situated between the supply line and the return line.

7. The system according to claim 6, wherein the heat transfer element is adapted to a cross-sectional form of the supply line and of the return line.

8. The system according to claim 1, wherein the supply line and the return line in a region of the thermal coupling run through an insulating shell filled with a heat-conducting medium.

9. The system according to claim 1, wherein at least one of the supply line and the return line in a region of the thermal coupling has heat-conducting ribs in an interior for improving a transfer of heat into at least one of (a) a wall of the line and (b) interference elements for producing at least one of swirls and turbulences.

10. The system according to claim 1, wherein the supply line and the return line in a region of the thermal coupling run parallel.

11. The system according to claim 1, further comprising a coupling heat exchanger situated outside of the heat exchanger between the supply line and the return line for transferring a portion of heat of the hot heating water from the supply line into the cooled heating water in the return line.

12. The system according to claim 1, wherein the control valve is an OPEN/CLOSE valve, an OPEN duration and thus a heating water flow rate being controlled by a PWM signal.

13. A system for at least one of heating and air-conditioning of a motor vehicle, comprising:
a heater circuit having a heat exchanger that has heating water flowing through it for bringing climate control air to be supplied to a vehicle interior to a preselected temperature;
a supply line for supplying hot heating water to the heat exchanger;
a return line for removing cooled heating water from the heat exchanger; and
a control valve for regulating a flow quantity of the heating water flowing through the heat exchanger,
wherein the supply line and the return line are thermally coupled inside the heat exchanger.
